(19) United States
(12) Patent Application Publication
(10) Pub. No.: US 2006/0237286 A1
(43) Pub. Date: Oct. 26, 2006

(54) System and method for positioning imaging plates within a cassette tray

(75) Inventor: Chang J. Yee, Stow, MA (US)

Correspondence Address: HOWARD J. GREENWALD P.C., 349 W. COMMERCIAL STREET SUITE 2490, EAST ROCHESTER, NY, 14445-2408, US

(73) Assignee: ECRM Incorporated, Tewksbury, MA (US)

(21) Appl. No.: 11/113,329

(22) Filed: Apr. 25, 2005

(51) Int. Cl. B65G 47/26

(52) U.S. Cl. 198/434

(57) ABSTRACT

In one embodiment of the present invention, an apparatus for lifting an object includes a rotational axis that has a first lead screw threaded in a first direction, a second lead screw threaded in a second direction, and a coupler that couples the first lead screw and the second lead screw. A first lifting arm has first and second members that move in a first plane that is substantially parallel to the rotational axis, and a second lifting arm has first and second members that move in a second plane that is substantially parallel to the rotational axis. A first transverse member is coupled to the first lead screw, and a second transverse member is coupled to the second lead. Rotation of the rotational axis in a first direction raises the first and second lifting arms, and rotation of the rotational axis in a second direction lowers the first and second lifting arms.

### BACKGROUND OF THE INVENTION

1. Field of the Invention

The present invention relates generally to a system and method for positioning imaging plates within a cassette tray used in connection with, for example, Computer-to-Plate (CTP) imaging systems.

2. Background Description

Automating the printing process in Computer-to-Plate (CTP) imaging systems involves the alternating process of extracting plate sheet material, and then interleaf sheet material, from a material stack. Images are exposed on the plate sheet material, and the interleaf sheet material is used to protect the imaging surface of plate sheets from each other.

Interleaf sheets, though varying from manufacturer to manufacturer in material characteristics such as smoothness, porosity, and color, are generally paper-like with a thickness of about 0.003 inches. Plate sheet material typically varies in thickness from 0.005 inches to 0.014 inches.

Extracting the plate sheets and interleaf sheets manually is labor intensive, but normally does not present other issues or challenges. Plate sheets and/or interleaf sheets may be automatically removed by using, for example, a “pick and drag approach” that generally includes precise plate lifting at a controlled rate and height, air blowing to create an air cushion between the bottom of the plate and top of the slipsheet, static brushes, and air ionization to help neutralize static. All these events can vary in time and intensity depending on the plate dimensions (length, width, and thickness) and/or the height needed to lift and clear the inherent cassette containment wall depth.

Plate sheet cassettes typically hold approximately 60 plates and slipsheets. If a plate is 0.012 inches thick and a slipsheet is 0.003 inches thick, this amounts to a relatively shallow depth to overcome when picking up plates and slipsheets that are located toward the bottom of the cassette. However, even within this relatively shallow range of depth, the events can be numerous and complex, as described above. I have determined that the “pick and drag approach,” for example, becomes even more challenging and less reliable when plate sheets and interleaf sheets are extracted from a deeper (higher capacity) cassette. I have determined, therefore, that a system that can keep image plates at a constant height as they are removed would facilitate removing plate sheets and interleaf sheets from a cassette.

### SUMMARY OF THE INVENTION

Embodiments of the present invention relate generally to Computer-to-Plate (CTP) imaging systems and, more particularly, to systems and methods for enabling the top of the plate/interleaf stack height to remain relatively close to the opening of the cassette to minimize and maintain the same or substantially the same pick-up mechanism lift height.

Embodiments of the present invention generally lift an entire stack of imaging plates and alternating interleaf sheets as they are removed from the top of the cassette to keep the top imaging plate within the stack at a same position, as imaging plates are removed from the stack.

In one embodiment of the present invention, an apparatus for lifting an object is provided that includes a rotational axis. The rotational axis can include a first lead screw that is threaded in a first direction, a second lead screw that is threaded in a second direction and that is axially aligned with the first lead screw, and a coupler that couples the first lead screw and the second lead screw. A first lifting arm includes first and second members that move in a first plane that is substantially parallel to the rotational axis, and a second lifting arm that includes first and second members that move in a second plane that is substantially parallel to the rotational axis. The rotational axis is positioned between the first lifting arm and the second lifting arm.

In addition, a first transverse member is coupled to the first lead screw. The first transverse member has a portion that contacts the first member of the first lifting arm and the first member of the second lifting arm. A second transverse member is coupled to the second lead screw. The second transverse member has a portion that contacts the second member of the first lifting arm and the second member of the second lifting arm. Rotation of the rotational axis in a first direction raises the first and second lifting arms, and rotation of the rotational axis in a second direction lowers the first and second lifting arms.

The first lead screw can be operably connected to a motor that rotates the rotational axis in the first direction and the second direction. A first push bar can be used that has a nut that is threaded in the first direction, and mates with the first lead screw. A portion of the first push bar contacts the first transverse member. A second push bar can be used that has a nut that is threaded in the second direction, and mates with the second lead screw. A portion of the second push bar contacts the second transverse member.

Rotation of the rotational axis in the first direction causes the first transverse member and the second transverse member to move toward each other. Rotation of the rotational axis in the second direction causes the first transverse member and the second transverse member to move away from each other.

A tray that receives objects, such as imaging plates, contacts the first lifting arm and the second lifting arm. At least a portion of the first and second lifting arms are positioned at opposing sides within a frame. In addition, opposing ends of the rotational axis respectively rotate about a first angle of contact bearing and a second angle of contact bearing.

In another embodiment of the invention, a method includes providing a rotational axis that includes a first lead screw threaded in a first direction, and providing a second lead screw that is threaded in a second direction. The first lead screw and the second lead screw are axially aligned. A coupler can be connected to the first lead screw and the second lead screw.

The method also includes providing a first lifting arm that has first and second members that move in a first plane that is substantially parallel to the rotational axis, and providing a second lifting arm that has first and second members that move in a second plane that is substantially parallel to the rotational axis.

A first transverse member is provided that is coupled to the first lead screw. The first transverse member has a portion contacting the first member of the first lifting arm and the first member of the second lifting arm. A second transverse member is provided that is coupled to the second lead screw. The second transverse member has a portion contacting the second member of the first lifting arm and the second member of the second lifting arm. The rotational axis is rotated in a first direction to raise the first and second lifting arms, and the rotational axis is rotated in a second direction to lower the first and second lifting arms.

A first push bar can be provided that has a nut that is threaded in the first direction and mates with the first lead screw. A second push bar can be provided that is threaded in the second direction and mates with the second lead screw. Rotating the rotational axis in the first direction moves the first transverse member and the second transverse member toward each other, and rotating the rotational axis in the second direction moves the first transverse member and the second transverse member away from each other.

In another embodiment of the invention, a method includes utilizing a rotational axis that has a first lead screw threaded in a first direction, and a second lead screw threaded in a second direction. The first lead screw and the second lead screw are axially aligned and coupled.

A first lifting arm is utilized that includes first and second members that move in a first plane that is substantially parallel to the rotational axis. A second lifting is utilized that includes first and second members that move in a second plane that is substantially parallel to the rotational axis.

A first transverse member is utilized that is coupled to the first lead screw. The first transverse member has a portion that contacts the first member of the first lifting arm and the first member of the second lifting arm. A second transverse member, coupled to the second lead screw, has a portion contacting the second member of the first lifting arm and the second member of the second lifting arm. The rotational axis is rotated in a first direction to raise the first and second lifting arms, and a second direction to lower the first and second lifting arms.

A first push bar can be provided that has a nut that is threaded in the first direction and mates with the first lead screw. A second push bar can be provided that has a nut that is threaded in the second direction and mates with the second lead screw. Rotating the rotational axis in the first direction moves the first transverse member and the second transverse member toward each other. Rotating the rotational axis in the second direction moves the first transverse member and the second transverse away from each other.

### BRIEF DESCRIPTION OF THE DRAWINGS

The Detailed Description including the description of preferred structures as embodying features of embodiments of the invention will be best understood when read in reference to the accompanying figures wherein:

FIG. 1 is a perspective view of a Computer-to-Plate (CTP) imaging system, also showing an exemplary docking interface for a imaging cassette cart.

FIG. 2 is a perspective view of an exemplary imaging cassette cart, with a cassette tray having a lifting platform in a lowered position.

FIG. 3A is a perspective view of the imaging cassette tray shown in FIG. 2 with the lifting platform in a raised position.

FIG. 3A is a perspective view of the imaging cassette tray shown in FIG. 2 with the lifting platform in a lowered position.

FIG. 4 is a perspective view of the cassette tray shown in FIG. 2 with the lifting platform removed.

FIG. 5 is a perspective view of a first exemplary apparatus that can be used to raise and lower the cassette lifting platform.

FIG. 6A is a first perspective view of a second exemplary apparatus that can be used to raise and lower the cassette lifting platform, with lifting arms in a raised position.

FIG. 6B is a second perspective view of a second exemplary apparatus that can be used to raise and lower the cassette lifting platform, with lifting arms in a raised position.

FIG. 6C is a third perspective view of a second exemplary apparatus that can be used to raise and lower the cassette lifting platform, with lifting arms in a lowered position.

FIG. 6D is a fourth perspective view of a second exemplary apparatus that can be used to raise and lower the cassette lifting platform, with lifting arms in a lowered position.

### DETAILED DESCRIPTION OF A PREFERRED EMBODIMENT OF THE INVENTION

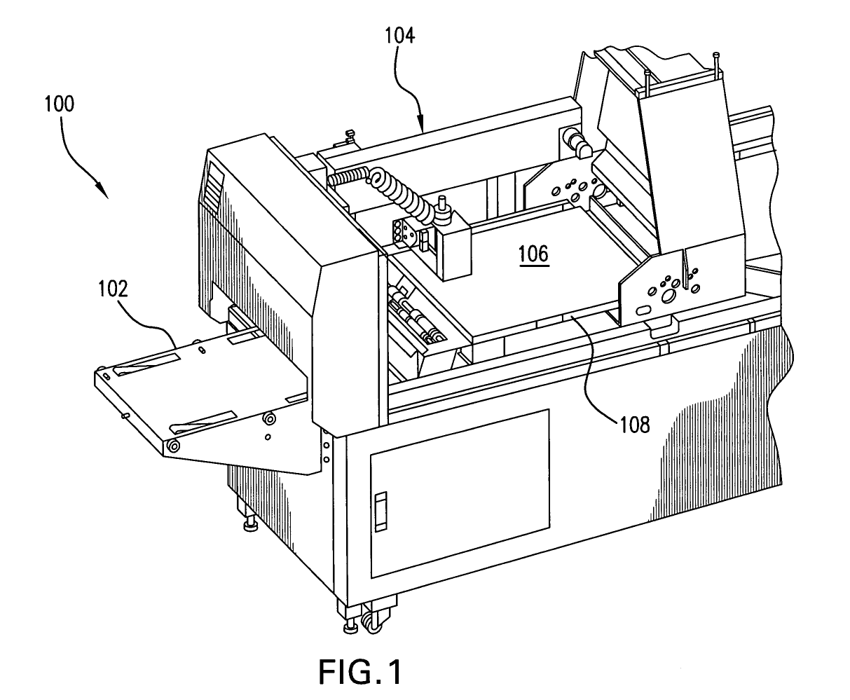

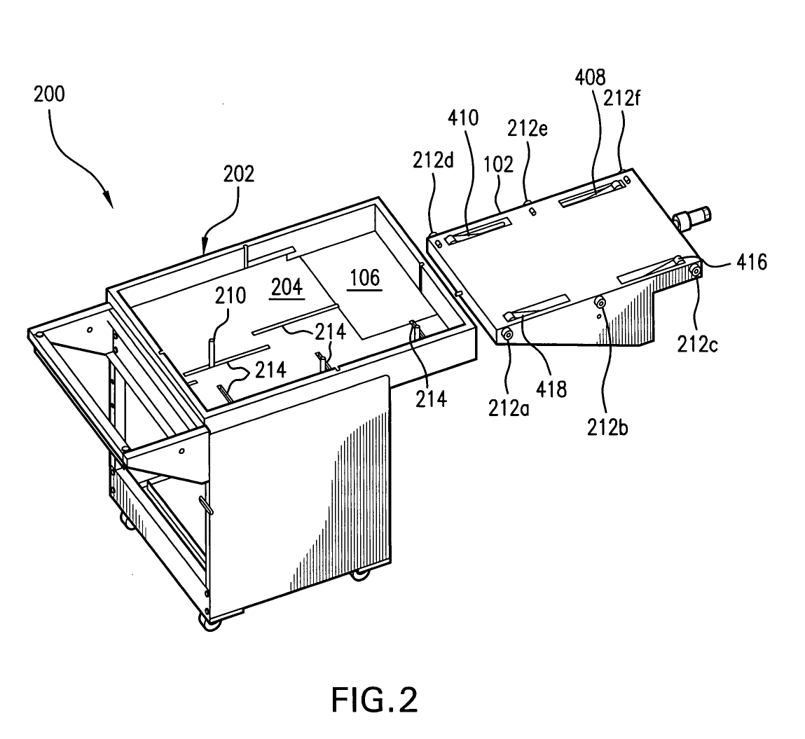

FIG. 1, generally at 100, is a perspective view of a Computer-to-Plate (CTP) imaging system, also showing an exemplary docking interface 102 for a imaging cassette cart, which is shown in FIG. 2, generally at 200. Apparatus 104 can be used to remove interleaf sheets (not shown) from plate sheets 106, remove plate sheets 106 from interleaf sheets, and/or transport plate sheets 106 to input shelf 108. When plate sheets 106 are received at input shelf 108, system 100 generally utilizes one or more lasers to perform plate sheet imaging in a standard manner.

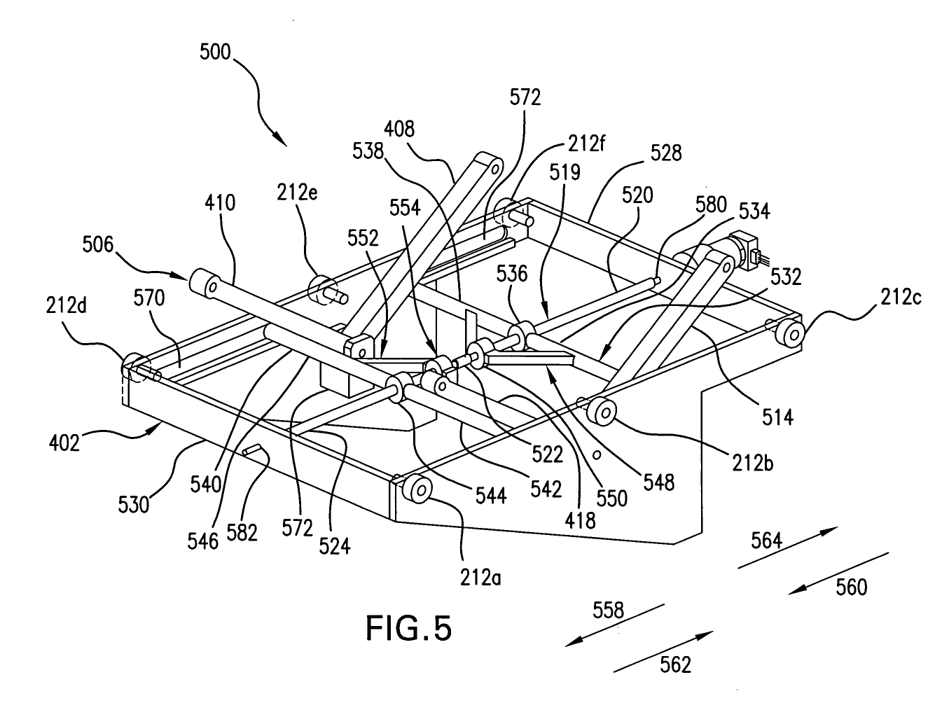

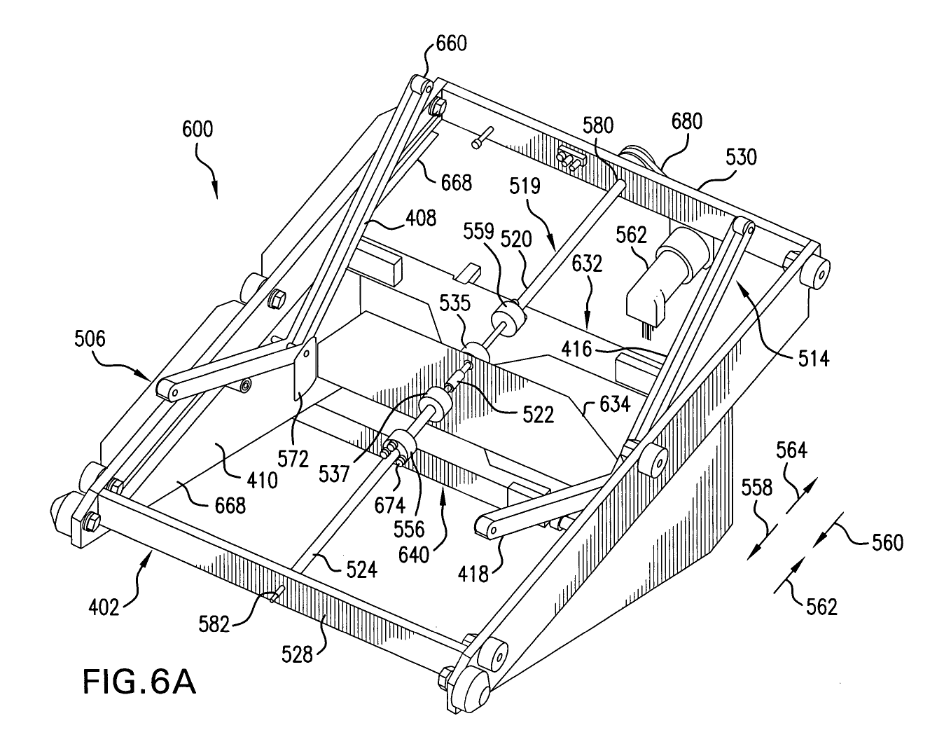

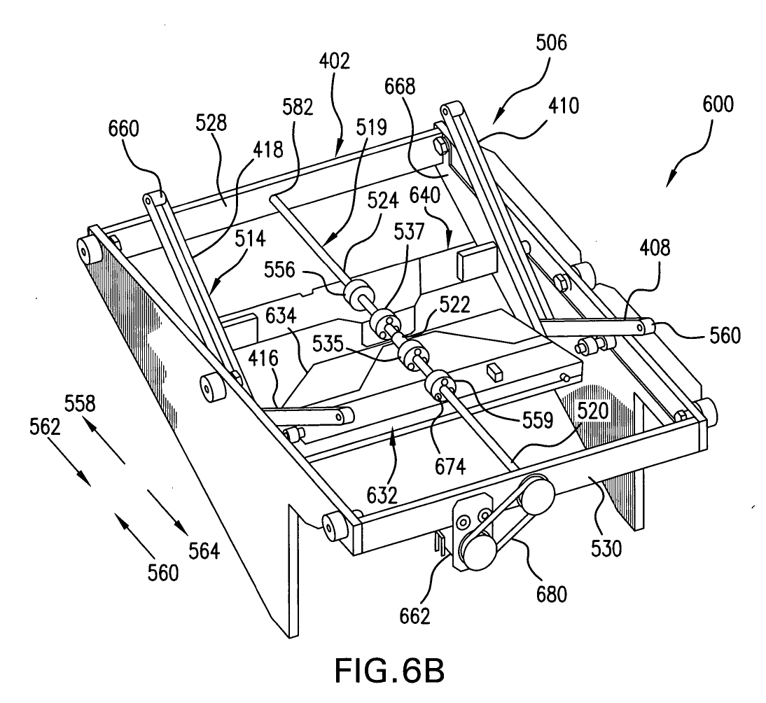

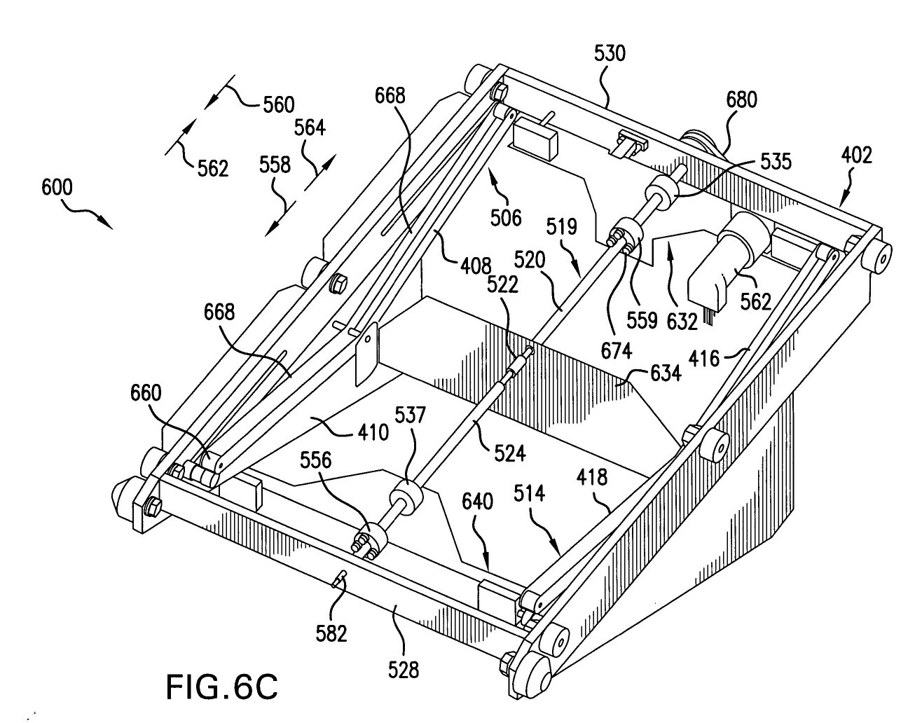

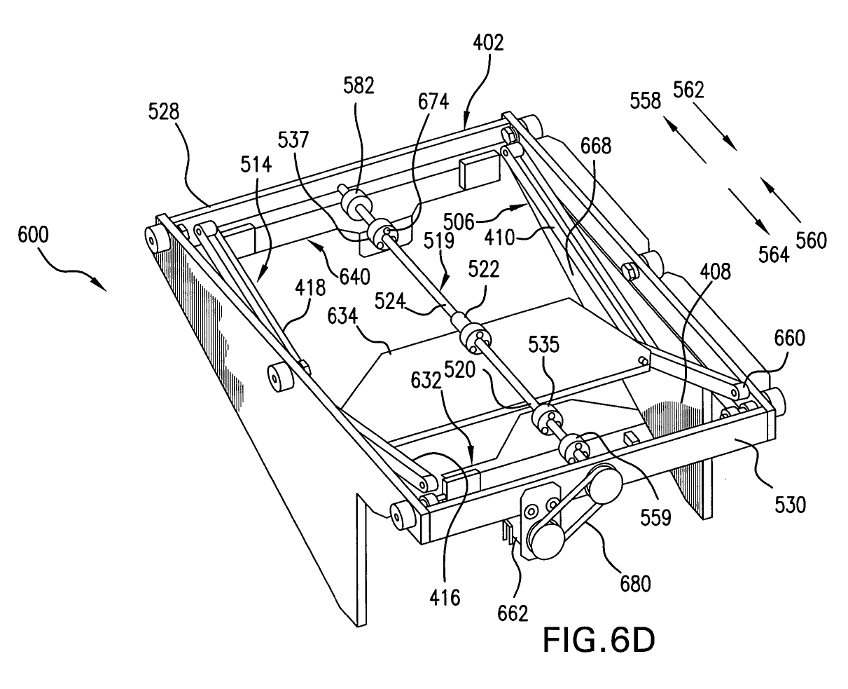

FIG. 2 is a perspective view of an exemplary imaging cassette cart 200, with a cassette tray 202 having a lifting platform 204 that is used to raise and lower plate sheets 106. Lifting platform 204 is shown in a lowered position. Plate sheets 106 will generally have an interleaf sheet interposed therebetween. Lifting platform 204 is used to support plate sheets 106 and any alternating interleaf sheets. A plurality of position rods 210 that move within slots 214 can be provided to accommodate varying size plate sheets 106. That is, one or more position rods 210 can be positioned within close proximity of or contacting a plate sheet 106 to secure plate sheet 106 in position. Docking interface 102 can have a plurality of rollers 212a-f that mate, for example, with respective slots (not shown) of cassette tray 202. First arms 408, 416 and second arms 410, 418 are discussed in connection with FIGS. 5 and 6A-6D.

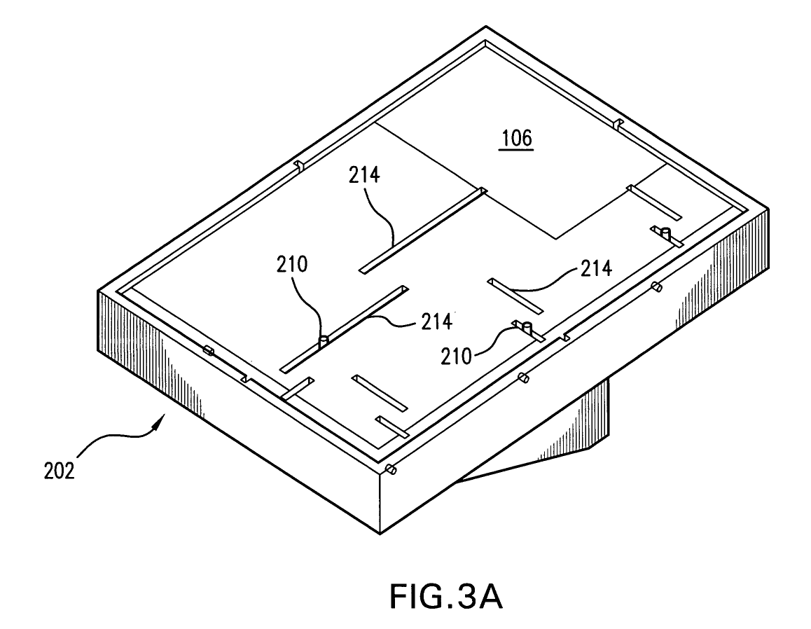

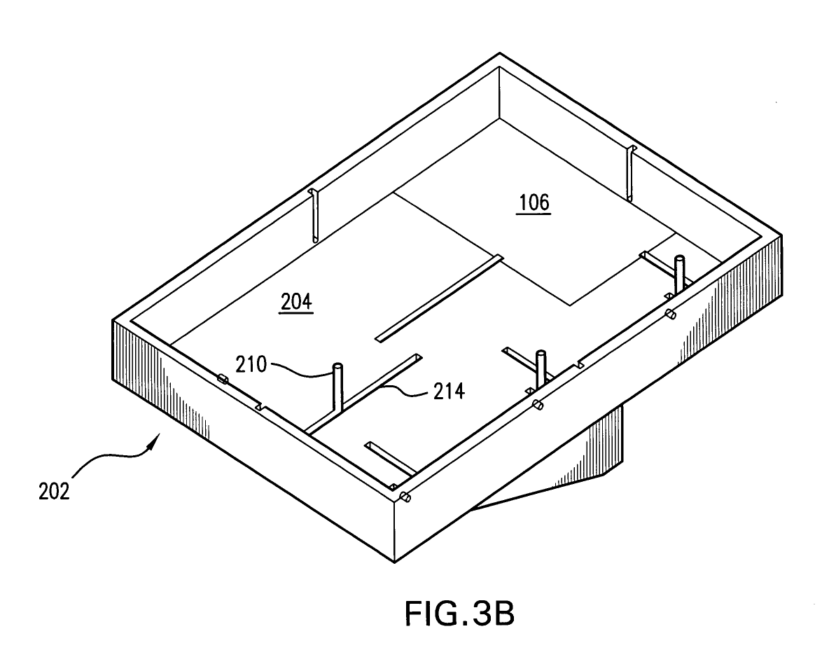

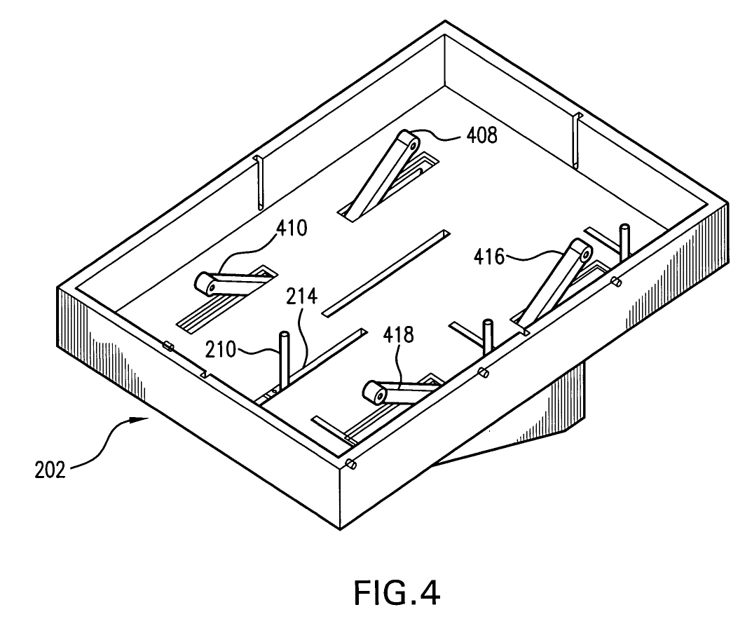

FIG. 3A is a perspective view of the imaging cassette tray 202 shown in FIG. 2, with lifting platform 204 in a raised position. FIG. 3B is a perspective view of the imaging cassette tray 202 shown in FIG. 2, with lifting platform 204 in a lowered position. FIG. 4 is a perspective view of cassette tray 202 shown in FIG. 2 with the lifting platform 204 removed. A portion of first arms 408, 416 and second arms 410, 418, which are discussed in more detail in connection with FIGS. 5 and 6a-6D, are shown extending through lifting platform 204.

FIG. 5, generally at 500, is a perspective view of an exemplary apparatus that can be used to raise and lower lifting platform 204. In FIG. 5, a bottom surface of lifting platform 204 (not shown in FIG. 5) can contact lift arms 506, 514. An intermediate plate (not shown) can also be positioned between a bottom surface of lifting platform 204 and a top surface of docking interface 102. Lift arm 506 includes first arm 408 and second arm 410. A pivot 572, or similar mechanism, is used to facilitate rotation of first arm 408 and second arm 408. Similarly, lift arm 514 includes first arm 416 and second arm 418. Plate sheets 106 and interleaf sheets (not shown) contact a top surface of lifting platform 204. A pivot (not shown), or similar mechanism, can also be used to facilitate rotation of first arm 416 and second arm 418.

Rotational axis 519 includes a first lead screw 520 that is threaded in a first direction (e.g. right handed), a second lead screw 524 that is threaded in a second direction (e.g., left handed), and a coupler 522 that couples the first lead screw 520 and the second lead screw 524. The first lead screw 520, coupler 522, and second lead screw are generally in axial alignment.

First arm 408 and second arm 410 move generally planar and parallel to rotational axis 519. Similarly, first arm 416 and second arm 418 move generally planar and parallel to rotational axis 519, which is positioned between lift arm 506 and lift arm 514.

First transverse member 532 includes first element 534 and second element 538 that are coupled by clearance hole 536. First lead screw 520 rotates in clearance hole 536. A portion of first element 534 contacts first arm 416, and a portion of second element 538 contacts second arm 418. First push bar 548 has a threaded hole 550 (e.g., a nut) that is also threaded in the first direction, to mate with first lead screw 520. A portion of first push bar 548 contacts first element 534 and second element 538.

Similarly, second transverse member 540 includes first element 542 and second element 546 that are coupled by clearance hole 544. Second lead screw 524 rotates in clearance hole 544. A portion of first element 542 contacts second arm 418, and a portion of second element 546 contacts second arm 410. Second push bar 552 has a threaded hole 554 (e.g., a nut) that is also threaded in the second direction, to mate with second lead screw 524. A portion of second push bar 552 contacts first element 542 and second element 546. First transverse member 532 and second transverse member 540 can ride in slots (e.g., slot 570) within opposing sides of frame 402. Clearance holes 536, 544 could also be threaded in addition to or in lieu of threaded holes 550, 554.

When a motor (not shown) is used to drive rotational axis 519 in a first direction (e.g., clockwise), the rotation of rotational axis 519 within threaded hole 550 causes first push bar 548 to move first transverse member 532 in the direction of arrow 564, thus lowering first arm 408 and first arm 416. Similarly, when a motor is used to drive rotational axis 519 in the second direction, the rotation of rotational axis 519 within threaded hole 554 causes second push bar 552 to move second transverse member 540 in the direction of arrow 558, thus lowering second arm 410 and second arm 418. A first contact bearing (not shown) and a second contact bearing (not shown) respectively positioned in openings 580, 582 can respectively be used to facilitate rotation of first lead screw 520 and second lead screw 524.

Similarly, when a motor is used to drive rotational axis 519 in a second direction (e.g., counterclockwise), the rotation of rotational axis 519 within threaded hole 550 causes first push bar 548 to move first transverse member 532 in the direction of arrow 560, thus raising first arm 408 and first arm 416. Similarly, when a motor is used to drive rotational axis 519 in the second direction, the rotation of rotational axis 519 within threaded hole 554 causes second push bar 552 to move second transverse member 540 in the direction of arrow 562, thus raising second arm 410 and second arm 418. The raising an lowering of first arm 408, second arm 410, first arm 416, and second arm 416 raises and lowers lifting platform 204 (FIG. 2). Lifting platform is generally in a lowest position (and thus first arm 408, second arm 410, first arm 416, and second arm 416 are generally in their lowest position) when the cassette tray 202 is fully loaded. As imaging occurs and plates are removed from cassette tray 202, lifting platform 204 is generally raised (and thus first arm 408, second arm 410, first arm 416, and second arm 416 are also generally raised) as cassettes are removed from tray 202 for imaging.

FIGS. 6A-6D shown a second embodiment of the invention. FIG. 6A is a first perspective view of an apparatus 600 that can be used to raise and lower the cassette lifting platform 204, with lifting arms 506, 514 in a raised position. FIG. 6B is a second perspective view of an apparatus 600 that can be used to raise and lower the cassette lifting platform 204, with lifting arms 506, 514 in a raised position. FIG. 6C is a third perspective view of an apparatus 600 that can be used to raise and lower the cassette lifting platform 204, with lifting arms 506, 514 in a lowered position. FIG. 6D is a fourth perspective view of an apparatus 600 that can be used to raise and lower the cassette lifting platform 204, with lifting arms 506, 514 in a lowered position.

A bottom surface of lifting platform 204 (not shown in FIGS. 6A-6D) can contact lift arms 506, 514. Lift arm 506 includes a first arm 408 and a second arm 410. Similarly, lift arm 514 includes first arm 416 and second arm 418. Plate sheets 106 and interleaf sheets (not shown) contact a top surface of lifting platform 204. Each of first arm 406, first arm 416, second arm 410 and second arm 418 can utilize a roller 660 which contacts a bottom surface of lifting platform 204 to facilitate the raising and lowering of platform 204. An intermediate plate (not shown) can also be positioned between a bottom surface of lifting platform 204 and a top surface of docking interface 102, so that rollers 550 contact the intermediate plate. A pivot (not shown), or similar mechanism, can also be used to facilitate rotation of first arm 416 and second arm 418.

Rotational axis 519 includes a first lead screw 520 that is threaded in a first direction (e.g. right handed), a second lead screw 524 that is threaded in a second direction (e.g., left handed), and a coupler 522 that couples the first lead screw 520 and the second lead screw 524. The first lead screw 520, coupler 522, and second lead screw are generally in axial alignment.

First arm 408 and second arm 410 move generally planar and parallel to rotational axis 519. Similarly, first arm 416 and second arm 418 move generally planar and parallel to rotational axis 519. Rotational axis 519 is positioned between lift arm 506 and lift arm 514. Transverse plate 634 can contact, for example, an internal portion of opposing sides of frame 402 to provide support and/or guide rotation of rotational axis 519.

First transverse member 632 can have donut 559 attached thereto. Nuts 674, for example, can be used to secure donut 559 to first transverse member. First transverse member 632 and donut 559 provide support and/or guide rotation of rotational axis 519. Similarly, second transverse member 640 can have donut 556 attached thereto. Second transverse member 640 and donut 556 also provide support and/or guide rotation of rotational axis 519. Rails 668 can be used to facilitate movement of first transverse member 632 and second transverse member 640 in the direction of arrows 564, 558 and 560, 562.

First transverse member 632 has a threaded hole 535 (e.g., a nut) that is also threaded in the first direction, to mate with first lead screw 520. Similarly, second transverse member 640 had a threaded hole 537 (e.g., a nut) that is also threaded in the second direction, to mate with second lead screw 524.

When motor 662 and belt 680 used to drive rotational axis 519 in a first direction (e.g., clockwise), the rotation of rotational axis 519 within threaded hole 535 causes first transverse member 632 to move in the direction of arrow 564, thus lowering first arm 408 and first arm 416. Similarly, when motor 662 is used to drive rotational axis 519 in the second direction, the rotation of rotational axis 519 within threaded hole 537 causes second transverse member 640 to move in the direction of arrow 558, thus lowering second arm 410 and second arm 418. A first contact bearing (not shown) and a second contact bearing (not shown) can respectively positioned in openings 580, 582 to facilitate rotation of first lead screw 520 and second lead screw 524.

Similarly, when motor 662 is used to drive rotational axis 519 in a second direction (e.g., counterclockwise), the rotation of rotational axis 519 within threaded hole 535 causes first transverse member 632 to move in the direction of arrow 560, thus raising first arm 408 and first arm 416. Similarly, when motor 662 is used to drive rotational axis 519 in the second direction, the rotation of rotational axis 519 within threaded hole 537 causes second transverse member 640 to move in the direction of arrow 562, thus raising second arm 410 and second arm 418. The raising an lowering of first arm 408, second arm 410, first arm 416, and second arm 416 raises and lowers lifting platform 204 (FIG. 2). Lifting platform is generally in a lowest position (and thus first arm 408, second arm 410, first arm 416, and second arm 416 are generally in their lowest position) when the cassette tray 202 is fully loaded. As imaging occurs and plates are removed from cassette tray 202, lifting platform is generally raised (and thus first arm 408, second arm 410, first arm 416, and second arm 416 are also generally raised) as cassettes are removed from tray 202 for imaging.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

1. An apparatus, comprising:
a rotational axis comprising:
a first lead screw, threaded in a first direction;
a second lead screw, threaded in a second direction, axially aligned with the first lead screw; and
a coupler that couples the first lead screw and the second lead screw;
a first lifting arm comprising first and second members that move in a first plane that is substantially parallel to the rotational axis;
a second lifting arm comprising first and second members that move in a second plane that is substantially parallel to the rotational axis, wherein the rotational axis is positioned between the first lifting arm and the second lifting arm;
a first transverse member coupled to the first lead screw and having a portion contacting the first member of the first lifting arm and the first member of the second lifting arm; and
a second transverse member coupled to the second lead screw and having a portion contacting the second member of the first lifting arm and the second member of the second lifting arm;
wherein rotation of the rotational axis in a first direction raises the first and second lifting arms, and rotation of the rotational axis in a second direction lowers the first and second lifting arms.

2. The apparatus of claim 1, wherein the first lead screw is operably connected to a motor that rotates the rotational axis in the first direction and the second direction.

3. The apparatus of claim 1, further comprising a first push bar comprising a nut that is threaded in the first direction and mates with the first lead screw.

4. The apparatus of claim 3, wherein a portion of the first push bar contacts the first transverse member.

5. The apparatus of claim 1, further comprising a second push bar comprising a nut that is threaded in the second direction and mates with the second lead screw.

6. The apparatus of claim 5, wherein a portion of the second push bar contacts the second transverse member.

7. The apparatus of claim 1, further comprising:
a first push bar comprising a nut that is threaded in the first direction and mates with the first lead screw; and
a second push bar comprising a nut that is threaded in the second direction and mates with the second lead screw.

8. The apparatus of claim 7, wherein rotation of the rotational axis in the first direction causes the first transverse member and the second transverse member to move toward each other.

9. The apparatus of claim 7, wherein rotation of the rotational axis in the second direction causes the first transverse member and the second transverse member to move away from each other.

10. The apparatus of claim 1, further comprising a tray, for receiving objects, that contacts the first lifting arm and the second lifting arm.

11. The apparatus of claim 1, wherein at least a portion of the first and second lifting arms are positioned at opposing sides within a frame.

12. The apparatus of claim 1, wherein opposing ends of the rotational axis respectively rotate about a first angle of contact bearing and a second angle of contact bearing.

13. A method, comprising:
providing a rotational axis comprising a first lead screw, threaded in a first direction;
providing a second lead screw, threaded in a second direction, that is axially aligned with the first lead screw;
connecting a coupler to the first lead screw and the second lead screw;
providing a first lifting arm comprising first and second members that move in a first plane that is substantially parallel to the rotational axis;
providing a second lifting arm comprising first and second members that move in a second plane that is substantially parallel to the rotational axis;
providing a first transverse member coupled to the first lead screw, the first transverse member having a portion contacting the first member of the first lifting arm and the first member of the second lifting arm;
providing a second transverse member coupled to the second lead screw, the second transverse member having a portion contacting the second member of the first lifting arm and the second member of the second lifting arm;
rotating the rotational axis in a first direction to raise the first and second lifting arms; and
rotating the rotational axis in a second direction to lower the first and second lifting arms.

14. The method of claim 13, further comprising:
providing a first push bar comprising a nut that is threaded in the first direction and mates with the first lead screw; and
providing a second push bar comprising a nut that is threaded in the second direction and mates with the second lead screw, wherein rotating the rotational axis in the first direction moves the first transverse member and the second transverse member toward each other.

15. The method of claim 14, wherein rotating the rotational axis in the second direction moves the first transverse member and the second transverse member away from each other.

16. A method, comprising:
utilizing a rotational axis comprising a first lead screw, threaded in a first direction;
utilizing a second lead screw, threaded in a second direction, that is axially aligned with the first lead screw;
coupling the first lead screw and the second lead screw;
utilizing a first lifting arm comprising first and second members that move in a first plane that is substantially parallel to the rotational axis;
utilizing a second lifting arm comprising first and second members that move in a second plane that is substantially parallel to the rotational axis;
utilizing a first transverse member coupled to the first lead screw and having a portion contacting the first member of the first lifting arm and the first member of the second lifting arm;
utilizing a second transverse member coupled to the second lead screw and having a portion contacting the second member of the first lifting arm and the second member of the second lifting arm;
rotating the rotational axis in a first direction to raise the first and second lifting arms; and
rotating the rotational axis in a second direction to lower the first and second lifting arms.

17. The method of claim 16, further comprising:
providing a first push bar comprising a nut that is threaded in the first direction and mates with the first lead screw;
providing a second push bar comprising a nut that is threaded in the second direction and mates with the second lead screw; and
rotating the rotational axis in the first direction to move the first transverse member and the second transverse member toward each other.

18. The method of claim 17, further comprising rotating the rotational axis in the second direction to move the first transverse member and the second transverse away from each other.
